(19) United States
(12) Patent Application Publication
(10) Pub. No.: US 2014/0025774 A1
(43) Pub. Date: Jan. 23, 2014

(54) SYSTEMS AND METHODS FOR METADATA DRIVEN DYNAMIC WEB SERVICES

(71) Applicant: Aptean, Inc., Atlanta, GA (US)

(72) Inventors: Hemant "Sunny" GOSAIN, Redwood City, CA (US); Di ZHAO, San Carlos, CA (US); Saurabh RAVAL, Fremont, CA (US); Gary I. WU, Sunnyvale, CA (US)

(73) Assignee: Aptean, Inc., Atlanta, GA (US)

(21) Appl. No.: 13/920,596

(22) Filed: Jun. 18, 2013

Related U.S. Application Data
(63) Continuation of application No. 12/483,201, filed on Jun. 11, 2009, now abandoned.

(51) Int. Cl. H04L 29/08

(52) U.S. Cl. CPC H04L 67/02
USPC 709/217

(57) ABSTRACT

A web service enabled enterprise resource application. The enterprise resource application provides a business framework that includes a data dictionary. The data dictionary is a metadata model that describes business objects in the applications. Systems and methods are provided that automate the process of creating and updating services for key business functions and dynamically enables web services for customization, extensions and modules developed on top of the business framework. These web services are meta data driven and dynamic—the web services can be created, updated and enabled using the model driven platform. Systems and methods are also provided that automatically create and update web services for business functions based on the data dictionary model.

### PRIORITY

The present application is a continuation of U.S. patent application Ser. No. 12/483,201, filed Jun. 11, 2009, the contents of which are hereby incorporated by reference in their entirety into this disclosure.

### BACKGROUND

1. Field

The subject invention relates to the field of enterprise resource applications and, in particular, to dynamic web service enabled enterprise resource applications that are metadata driven.

2. Related Art

Enterprise resource applications such as Enterprise Resource Planning (ERP) and Customer Relationship Management (CRM) software systems are used by a wide range of businesses to manage and coordinate their business resources and business information. For example, these enterprise resource applications are used by businesses to share data among different divisions of the business, and to monitor and manage, for example, warehouse management, sales, customer histories, order management, and the like.

Many of these businesses, however, desire to integrate different features of different enterprise resource applications and third-party applications. For example, Compiere provides a business framework software tool for enterprise resource management and customer relationship management, and Salesforce offers a customer resource management tool. In another example, the Compiere software tool may require integration with a third party application that runs credit checks at a point of sale (POS) to complete a sales order. Currently, in order to allow a third party application to interact with the enterprise resource management data at Compiere, application programming interfaces must be hard coded in the Compiere software tool to allow direct access to the data in the database. In addition, for each type of data object in the database, a different application programming interface is required. Because of the time and expense required to code these application programming interfaces, it has been difficult to share this data.

Web services are tools that allow different computers to interact with one another that are accessed through a network such as the Internet. These web services, however, have only been used with enterprise resource applications using the API's described above. One type of web service is the Representational State Transfer (RESTful) web service. The RESTful web service provides a way to use standard GET and POST operations to access resources over the internet.

Accordingly, what is needed is a web service enabled enterprise resource application, and web service enabled enterprise resource applications that use RESTful web services.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, a method is provided that includes receiving a web service request to access data in an enterprise resource application; processing the web service request using metadata in the enterprise resource application; and generating a textual response using the metadata. In another aspect of the invention, a computer-readable storage media is provided having computer executable instructions stored thereon which cause a computer system to carry out the method when executed.

According to a further aspect of the invention, a method is provided that the metadata according to the request; and generating a web service corresponding to the modified metadata. In another aspect of the invention, a computer-readable storage media is provided having computer executable instructions stored thereon which cause a computer system to carry out the method when executed.

According to another aspect of the invention, a system is provided that includes a web layer configured to receive requests to access a business representation of data and deliver a response including the business representation of the data; a data dictionary configured to store metadata; and a persistent layer operatively coupled to the web layer and the data dictionary, the persistent layer configured to process the web service request using the metadata and generate the response.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram of an enterprise application according to one embodiment of the invention;

FIG. 2 is a block diagram of the model-driven application platform according to one embodiment of the invention;

FIG. 3 is a block diagram of a system that creates, updates and enables application web services based on the model-driven application platform according to one embodiment of the invention;

FIG. 4 is a flow diagram of a process for processing a web service request for data according to one embodiment of the invention;

FIG. 5 is a detailed flow diagram of a process for processing a web service request for data according to one embodiment of the invention;

FIG. 6 is a flow diagram of a process for adding and updating objects using web services according to one embodiment of the invention;

FIGS. 7A and 7B are a schematic diagram of an internal user interface for accessing the model-driven application platform using web services according to one embodiment of the invention; according to one embodiment of the invention;

FIGS. 8A and 8B are a schematic diagram of a web service request and response according to one embodiment of the invention;

FIGS. 9A and 9B are a schematic diagram of a third party user interface for accessing the model-driven application platform using web services according to one embodiment of the invention; and

FIG. 10 is a block diagram of an exemplary computer system according to one embodiment of the invention.

### DETAILED DESCRIPTION

Embodiments of the invention relate to a web service enabled enterprise resource application. The enterprise resource application provides a business framework that includes a data dictionary. The data dictionary is a metadata model that describes business objects, their interaction and user interface layer in the application. Embodiments of the invention automate the process of creating and updating services for key business functions and dynamically enables web services for customization, extensions and modules developed on top of the business framework. These web services are meta data driven and dynamic—the web services can be created, updated and enabled using the model driven platform of the data dictionary.

Web services produced this way provide a uniform interface to access the data dictionary so that users can retrieve any data from any object in the data dictionary, create new objects in the data dictionary, and update existing objects in the data dictionary. These users can be either internal users or third party users. In one embodiment, the web services provide a uniform interface to access data according to REST standards. The web services are advantageous because they provide the ability to perform searches on any object in the data dictionary, and because the system requires no code changes to the web services when changes are made to the data dictionary.

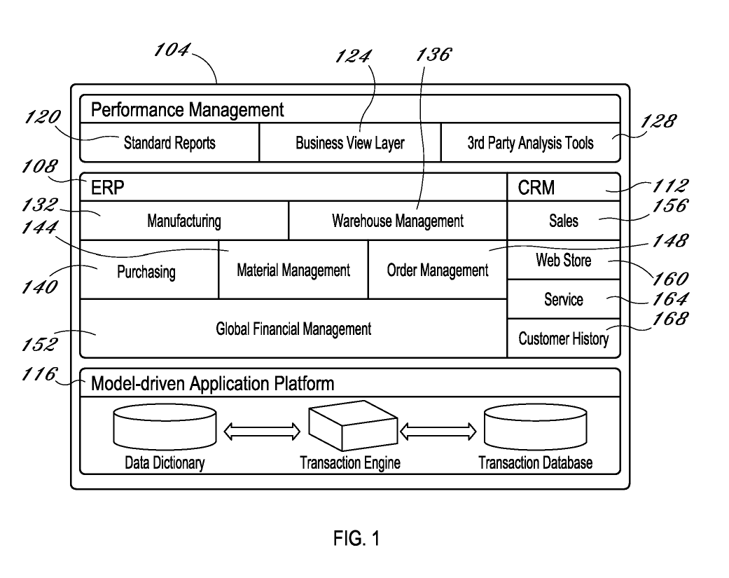

An embodiment of the invention will now be described in detail with reference to FIG. 1. FIG. 1 illustrates an exemplary enterprise application 100. As shown in FIG. 1, the exemplary enterprise application 100 includes performance management software tools 104, enterprise resource planning software tools 108, customer resource management software tools 112. The tools 104-112 are provided with a model-driven application platform 116.

The performance management software tools 104 provide company executives and managers with multiple views of operational performance and activities in the organization. Performance management software tools 104 include, for example, a standard report tool 120, a business view layer tool 124 and a third party analysis tool 128. The standard reports tool 120 allows a business to report and manage the performance of the business using standard reports and integrated reporting tools. The business view layer tool 124 allows for secure access to business data through optimized reporting schemas, and allows third party analysis tools to access data securely. Using application-level security controls, pre-defined business views are provided that span customer, vendor, product, sales order, invoice, and shipment data. Users can also add additional secured business views. The third party analysis tools 128 allow users to select third-party reporting and analysis tools to analyze the ERP and CRM data stored at the enterprise resource application 100.

The ERP tools 108 allow businesses to manage product lifecycles, manage supply chains, manage warehouses, support sales order processing, support financials, and the like. ERP tools 108 include, for example, a manufacturing tool 132, a warehouse management tool 136, a purchasing tool 140, a materials management tool 144, an order management tool 148 and a global finance management tool 152. The manufacturing tool 132 is configured to control manufacturing operations with material planning, production scheduling and shop floor execution capabilities. The warehouse management tool 136 improves warehouse productivity by automating inbound and outbound logistics. The purchasing tool 140 automates the steps from procurement to payment. The materials management tool 144 manages inventory receipts, shipments, moves and counts across your warehouses, suppliers and customers. The order management tool 148 creates quotes, book orders, manage materials, generate invoices and collect cash. The global financial management tool 152 automates the processes of business solutions and manages financial records.

The CRM tools 112 track and organize interactions between the business and its customers. CRM tools 112 include, for example, a sales tool 156, a web store tool 160, a service tool 164 and a customer history tool 168. The sales tool 156 is configured to control the customer relationship management solutions. The web store tool 160 is configured to allow businesses to create and run a secure web store front. The service tool 164 is configured to manage the service delivery lifecycle. The customer history tool 168 is configured to provide businesses with a full view of the interactions between the business and its customers.

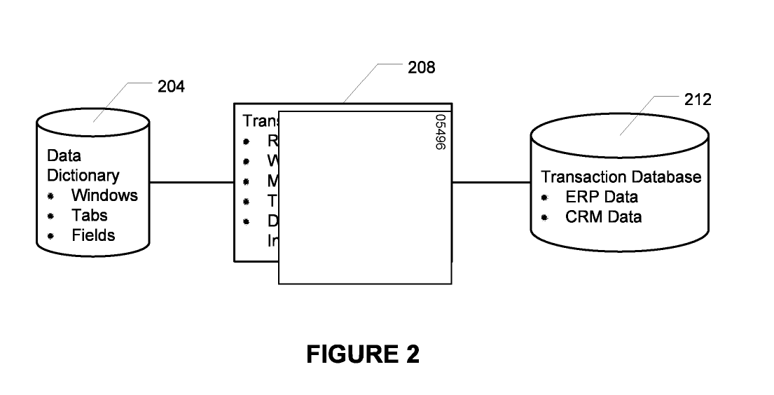

With reference to FIGS. 1 and 2 in combination, the model-driven application platform 116 provides a business framework to coordinate and implement the tools 104-168. The model-driven application platform 116 includes a data dictionary 204, a transaction engine 208 and a transaction database 212.

The data dictionary 204 stores data dictionary objects. These data dictionary objects include metadata (i.e., data that describes other data). The metadata includes, for example, windows, tabs, and fields that define the data in the data object (based on tables and columns defined as meta data in the dictionary), how the data associated with the data object is displayed and relationships among data and data objects. In one example, a data object for a sales order may include a sales order header that includes fields for customer information, shipping information and billing information, and sales order lines that identify fields for the line number, product, quantity and the like. The data dictionary 204 may also manage security and access control rules.

The transaction database 212 stores the ERP data and CRM data. For example, the ERP data and CRM data may include transaction data (e.g. invoices) and set-up data (e.g. customer information).

The transaction engine 208 is operatively coupled to the data dictionary 204 and the transaction database 212. The transaction engine 208 is configured to access data in the transaction database 212 when requests are received for data through the data dictionary 204. For example, the transaction engine 208 may generate a database command (e.g., SQL queries) to access data from the transaction database 212 using information from the data dictionary 204. The transaction 208 is able to filter database queries based on the data objects in the data dictionary 204. In one embodiment, it is the transaction engine 208 that manages the security and access control rules.

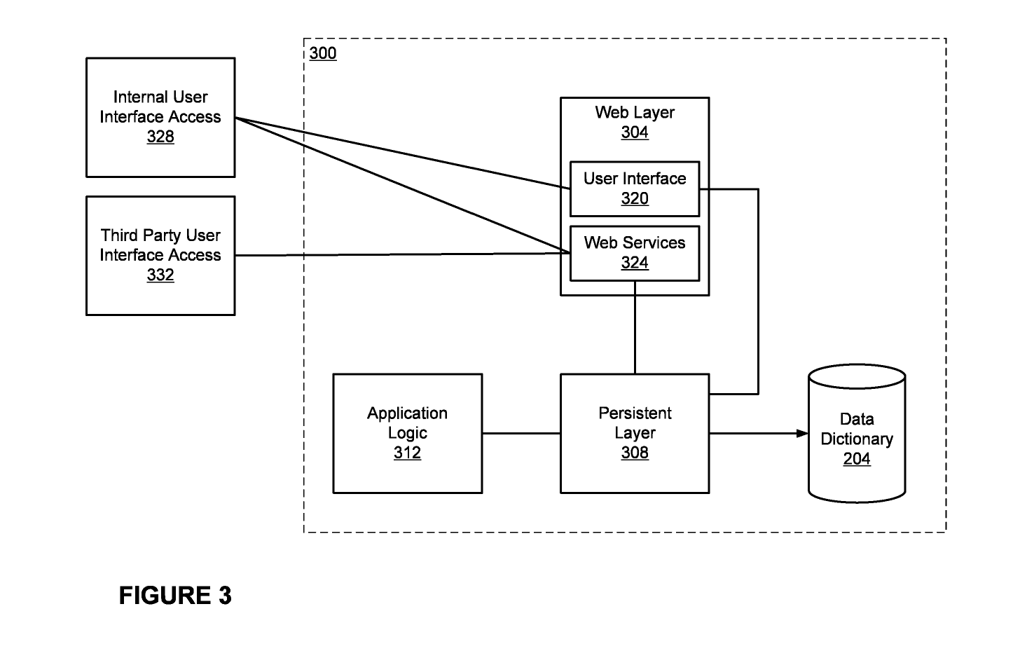

FIG. 3 illustrates the model-based application system that is web service enabled 300. The system 300 may be a server system that includes one or more processors, such as computers, and memory. The system 300 may also include network connections that allow users to interact with the web service enabled system 300 using web services. The network connections may include, alone or in combination, any type of communications channel, a local area network (LAN), a wide area network (WAN), such as the Internet, direct computer connections, and the like. The network connections may implement standard transmission protocols such as Transmission Control Protocol/Internet Protocol (TCP/IP), Hyper Text Transfer Protocol (HTTP) or other protocols. In one embodiment, the system 300 provides a uniform interface to access data using web services according to REST standards.

As shown in FIG. 3, the system 300 includes a web layer 304, a persistent layer 308, application logic 312 and the data dictionary 204. The web layer 304 is in communication with the persistent layer 308, which is in communication with the application logic 312 and the data dictionary 204. The web layer 304 may also be directly in communication with the data dictionary 204.

The application logic 312 is configured to store business rules and business constraints. The application logic 312 includes information such as a minimum order amount for a sales order application object, rules to ensure that hospital rooms are all male/all female, and the like. These business rules and business constraints can be used to filter web service requests at the persistent layer 308 or can be used to generate the response to a web service request at the persistent layer 308.

As described above, the data dictionary 316 includes data object definitions that are defined as metadata. The metadata includes, for example, windows, tabs and fields that define the structure and/or display of the data.

The web layer 304 includes a user interface application 320 and a web services application 324. The web layer 304 and, in particular, the user interface application 320, is operatively coupled through the network to an internal user interface access 328 and a third party user interface access 332.

The interfaces 328, 332 provide an interface to allow a user to interact with the web service enabled system 300 using web services. The interfaces 328, 332 may access the web layer 304 using an Internet browser such as Internet Explorer, Firefox, etc available on client computers. In one embodiment, the internal user interface 328 can access the system 300 through a software application that provides a direct connection to the model driven application platform 116 (e.g., a direct connection to the data dictionary 204). The client computers may be a server, a personal computer, a portable computer, a hand held device, a wireless device, and the like. The client computers may be a single device at a single location or multiple devices at a single or multiple locations that are connected together using an appropriate communication protocols over any communication medium.

The persistent layer 308 provides an interface between the web layer 304 and the data dictionary 204 and application logic 312. The persistent layer 308 receives web service requests from the web layer 304. The web service requests may be in the form of a URL. The URL may include an action, object and parameters or attributes. Exemplary actions may include query or search, create, update, delete and the like. An exemplary object and parameters include, for example, all sales orders for a particular customer (i.e., the object is the sales order object and the parameter is the customer).

The persistent layer 308 determines the logical representation of data that is responsive to the web service request by mapping physical data (e.g., data in the transaction database 212) to a business representation of the data using the data dictionary objects in the data dictionary 204. This logical representation of the data is provided as a response in a textual format. For example, the response may be an XML response. In one embodiment, the persistent layer 308 also includes rules that define security and how information is presented to the user.

The persistent layer 308 may use the business constraints and business rules in the application logic 312 to identify the information that is needed when the data dictionary 204 is queried. For example, the business constraint or business rule may indicate that the minimum order for a sales order web service request is $100. The persistent layer 308 can therefore filter its query of the data dictionary 204 to be limited to orders that have a minimum order of $100. Alternatively, the persistent layer 308 may use the business constraints and business rules in the application logic 312 to generate the response.

When a new object is created in the data dictionary 204, a new web service (e.g., URL that corresponds to that object) is generated automatically by the web service application interface 324. For example, the web service application interface 324 may generate a link to the new object. When new objects are defined in the data dictionary 204, code does not need to be written to enable web services for that object. Thus, the system 300 is a dynamic web service enabled system. The new object may be created by the third parties using web services (e.g., a web service request to add an object), or by the internal users using web services or by directly accessing the data dictionary 204 (e.g., a software application request).

Users are also able to change the structure of these data object definitions in the data dictionary 204 without coding, automatically, using the web services. Web services associated with the modified data object definitions are automatically generated at the web service application interface 324. These modifications may include, for example, a modification of a field, an addition of a field, a modification of a tab, addition of a tab, modification of a parameter, addition of a parameter, and the like.

In use, the interface accesses 328, 332 transmit a request to the web layer 304. For example, the web layer 304 receives a URL that includes an action, object and parameters. The action may, for example, be to add an object to the data dictionary, modify an object in the data dictionary or to search objects in the data dictionary. The web services application interface 324 processes the URL received at the web layer 304 and extracts the action, object and parameters. This information is then provided to the persistent layer 308. The persistent layer 308 then queries the data dictionary 204 using the action, object and parameters in the request. The query may be filtered at the persistent layer 308 using the application logic 312. The data dictionary 204 then retrieves the requested data from the transaction database 212. The persistent layer 308 generates a textual response (e.g., an XML response) that is a business representation of the retrieved data. For example, the persistent layer 308 may map the physical data from the transaction database 212 to the data object retrieved from the data dictionary 204.

In one embodiment, the persistent layer 308 generates a RESTful interface, which may be an XML interface. The persistent layer 308 may perform operations, such as, for example, GET, POST, and the like to process a web service request received at the web layer 304. For example, the data dictionary object associated with a sales order may include SOH and SOL parameters. If the web service request is a search for sales orders having certain parameters (e.g., all purchasers of Dell computers), the persistent layer generates and transmits a GET request to the data dictionary 204. The data dictionary 204 maps the parameters in the GET request (e.g., the SOH and SOL parameters) to the corresponding sales order object in the data dictionary 204. The data dictionary 204 then passes that request to the transaction engine 208 and transaction database 212 to access the requested data. When the requested data is returned to the persistent layer 308, the persistent layer 308 then covers the data to textual data (e.g., an

XML response). This textual response (e.g., XML response) is then returned to the interface access (e.g., client computer's browser) that provided the web service request.

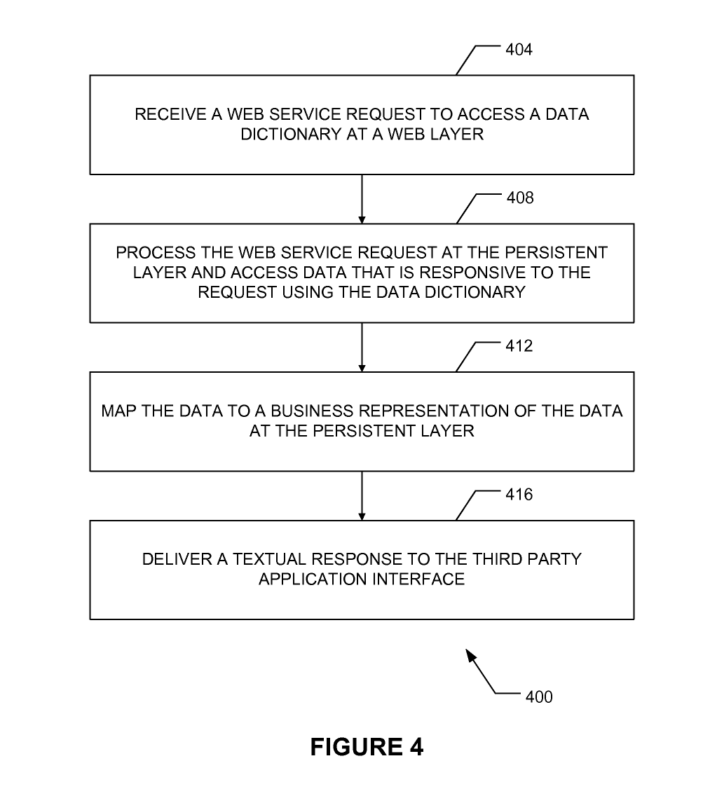

FIG. 4 illustrates a process 400 for processing a web service request at the system. It will be appreciated that the process 400 described below is merely exemplary and may include a fewer or greater number of steps, and that the order of at least some of the steps may vary from that described below.

The process 400 begins by receiving a web service request to access a data dictionary at a web layer (block 404). For example, the web layer 304 may receive a URL that includes an action to search for sales orders for a particular customer. The process 400 continues by processing the web service request at the persistent layer and accessing data that is responsive to the web service request using the data dictionary (block 408). For example, the web services application interface 324 may identify that the action is a search, the object is the sales order object and the parameter is the customer, and the persistent layer 308 may generate a query of the data dictionary 204 based on request information, which retrieves the requested data.

The process 400 continues by mapping the data to a business representation of the data at the persistent layer (block 412). For example, the persistent layer 308 maps the retrieved sales order data to the metadata (e.g., window, tab, fields based on table & columns definitions in the meta data) associated with the sales order object in the data dictionary 204. The process 400 continues by delivering a textual (e.g., XML) response to the third party application interface (block 416).

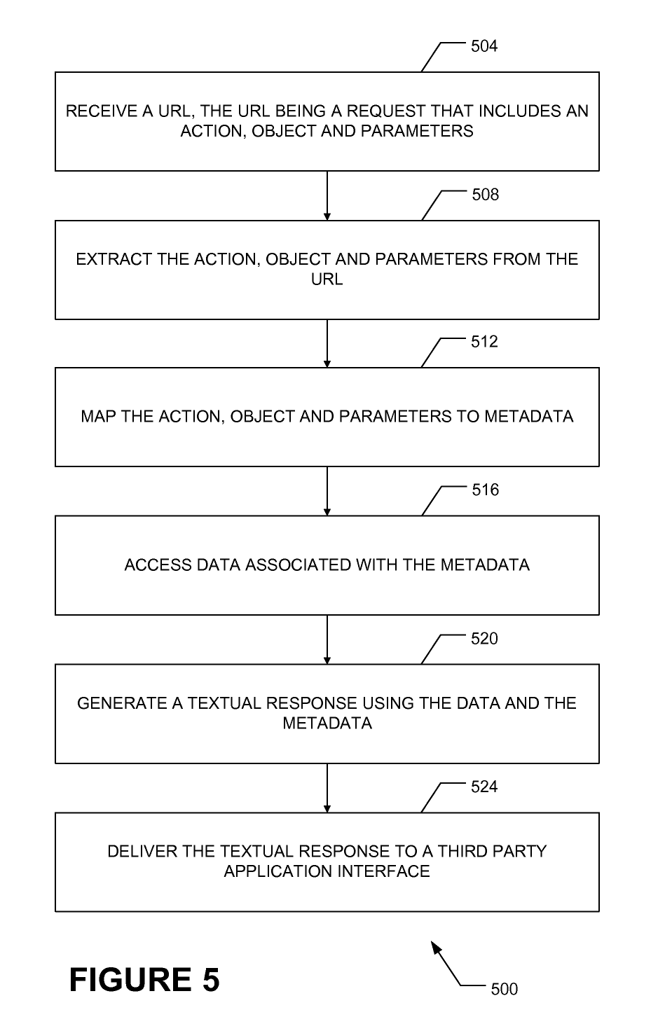

FIG. 5 illustrates a detailed process 500 for processing a web service request at the system. It will be appreciated that the process 500 described below is merely exemplary and may include a fewer or greater number of steps, and that the order of at least some of the steps may vary from that described below.

The process 500 begins by receiving a URL, the URL being a request that includes an action, object and parameters (block 504). The process 500 continues by extracting the action, object and parameters from the URL (block 508).

The process 500 continues by mapping the action, object and parameters to metadata (block 512). The process 500 continues by accessing data associated with the action, object and parameters (block 516).

The process 500 continues by generating a textual response using the data and metadata (block 520). The process 500 continues by delivering a textual response (block 524). In one embodiment, the textual response is delivered to a third party application, the response being a business representation of the data dictionary object that is responsive to the request.

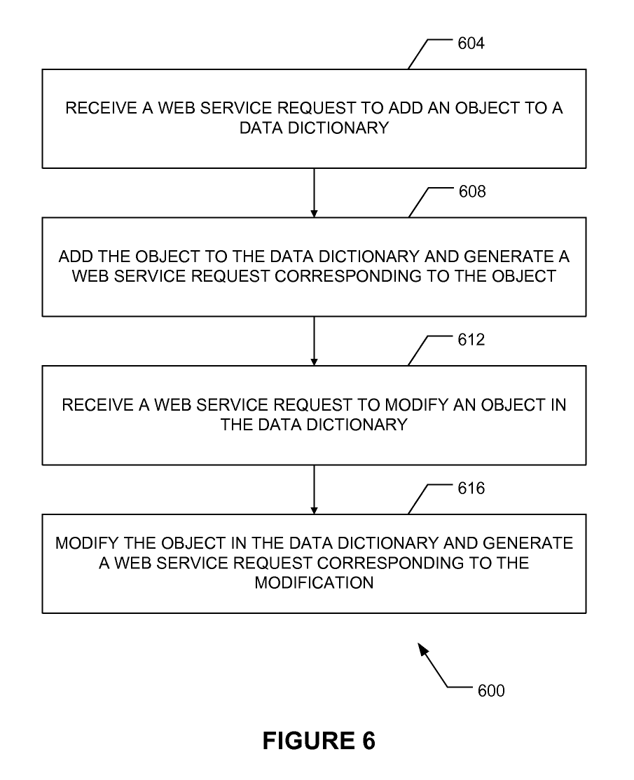

FIG. 6 illustrates a process 600 for adding and modifying objects in the data dictionary using web services. It will be appreciated that the process 600 described below is merely exemplary and may include a fewer or greater number of steps, and that the order of at least some of the steps may vary from that described below.

The process 600 begins by receiving a request to add an object to the data dictionary (block 604). For example, a user may create a new business partner table by creating a window. When the user performs these tasks at the interface and selects a button in the interface to create the window, a web service request is generated to add the object to the data dictionary.

The process 600 continues by adding the object to the data dictionary (block 608). For example, the persistent layer 308 determines that the action of the web service request is a request to add the object and then adds the object to the data dictionary using the parameters in the web service request. When the object is added to the data dictionary 204, the web service application interface 324 generates a web service request corresponding to that object so that users can perform searches using the new object. Thus, the process allows for dynamic web services because new objects can be defined in metadata (in the data dictionary 204) without writing code to enable web services.

The process 600 continues by receiving a request to modify an object in the data dictionary (block 612). For example, a user may open a business partner table, create a field, set the display name of the field, define the field parameter and place the field on the window. When the user performs these tasks at the interface and selects a button in the interface to place the field on the window, a web service request is generated to modify the object in the data dictionary and delivered to the web layer 304.

The process 600 continues by modifying the object in the data dictionary (block 616). For example, the persistent layer 308 determines that the action of the web service request is a request to modify the object. The persistent layer 308 then adds the field or performs another request modification to the data object associated with the window identified in the web service request using the parameters in the web service request. When the data object is modified, the web services application interface also generates a web service request corresponding to that modification so that users can perform searches on the modified data object. Exemplary modifications to the data object include deleting fields, changing the parameters of existing fields, modifying windows, adding windows, modifying tabs, adding tabs, and the like.

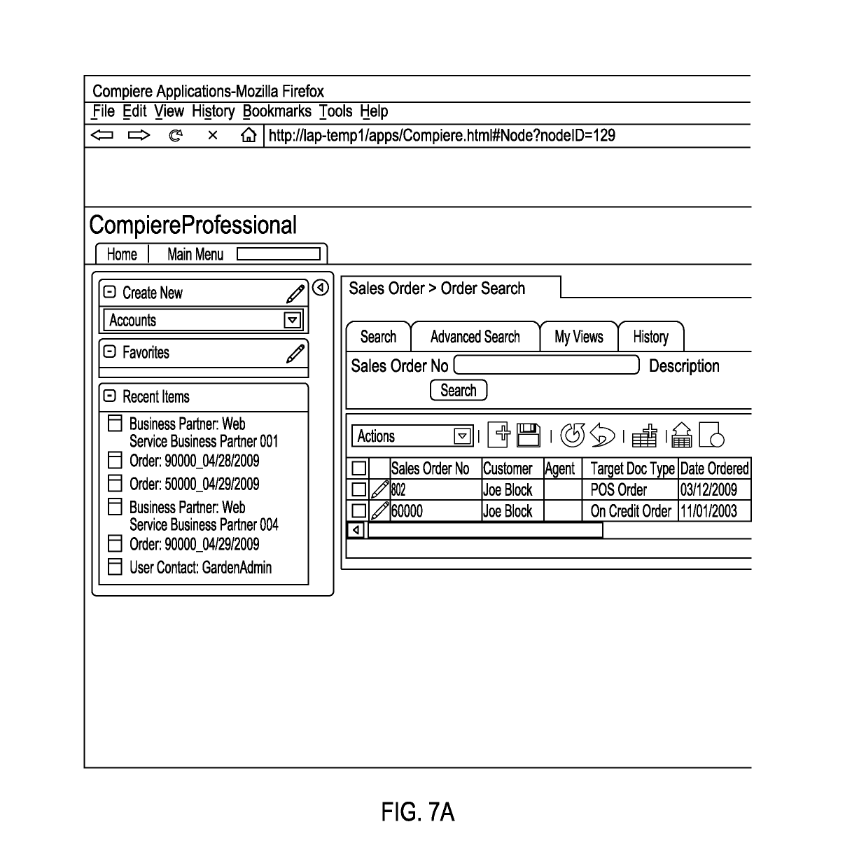

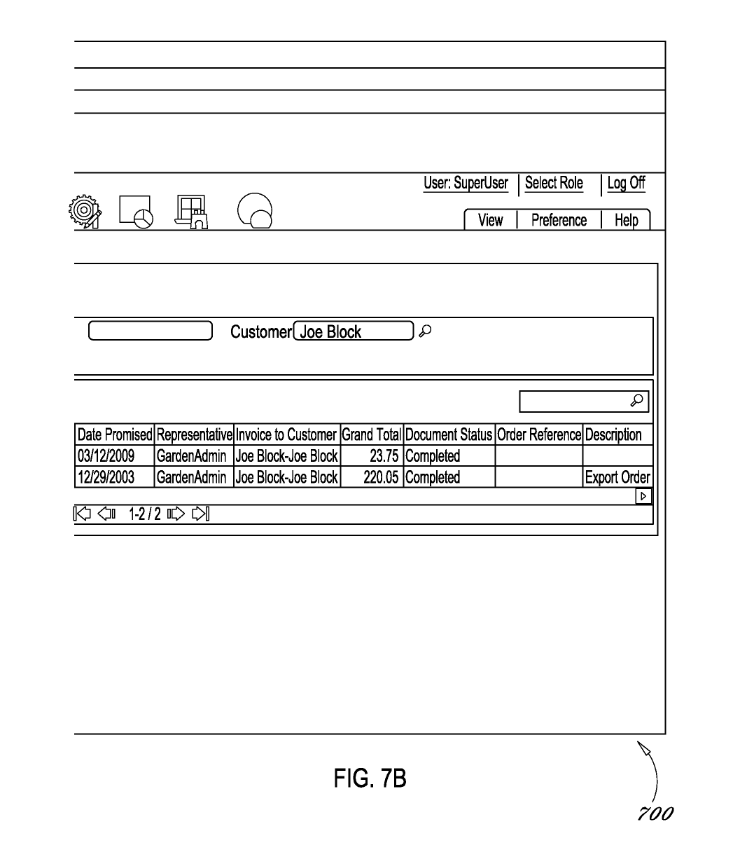

FIGS. 7A and 7B illustrates an exemplary internal user interface 700. The user interface 700 illustrates execution of a search for sales orders belonging to a customer “Joe Block” (i.e., a search executed from the interface access 328). In the illustrates user interface 700, the window includes four tabs, the selected tab including the search results for sales orders for “Joe Block”.

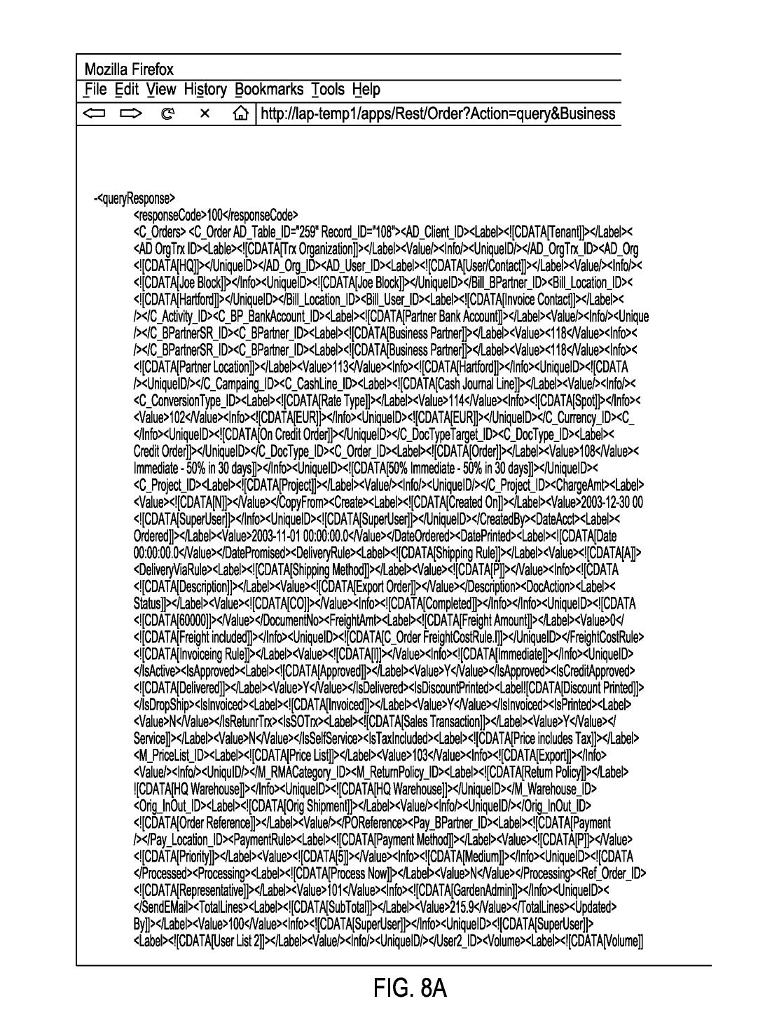

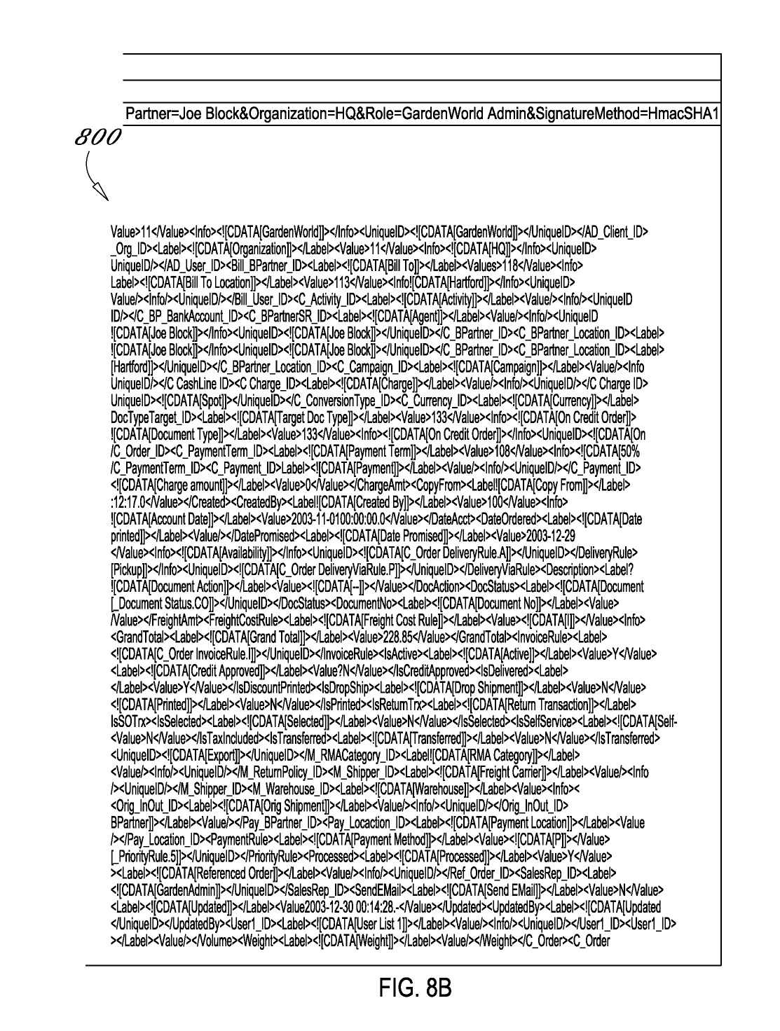

FIGS. 8A and 8B illustrates an exemplary XML response 800 to a web service request. As shown in FIGS. 8A and 8B, the search for sales orders for “Joe Block” using web services includes a URL that includes parameters such as “Joe Block”. The illustrated response returns the same data that is produced to the internal user interface 700 in response to the same search (i.e., request); however, the data is provided in XML format. The third party browser then displays the XML data according to its own requirements.

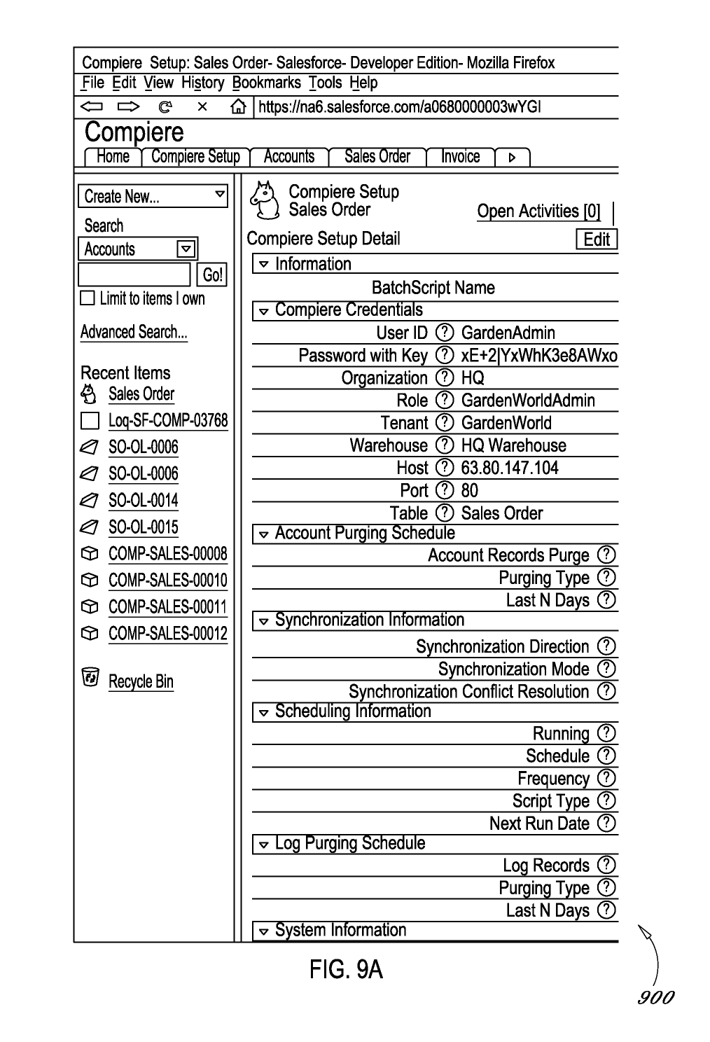

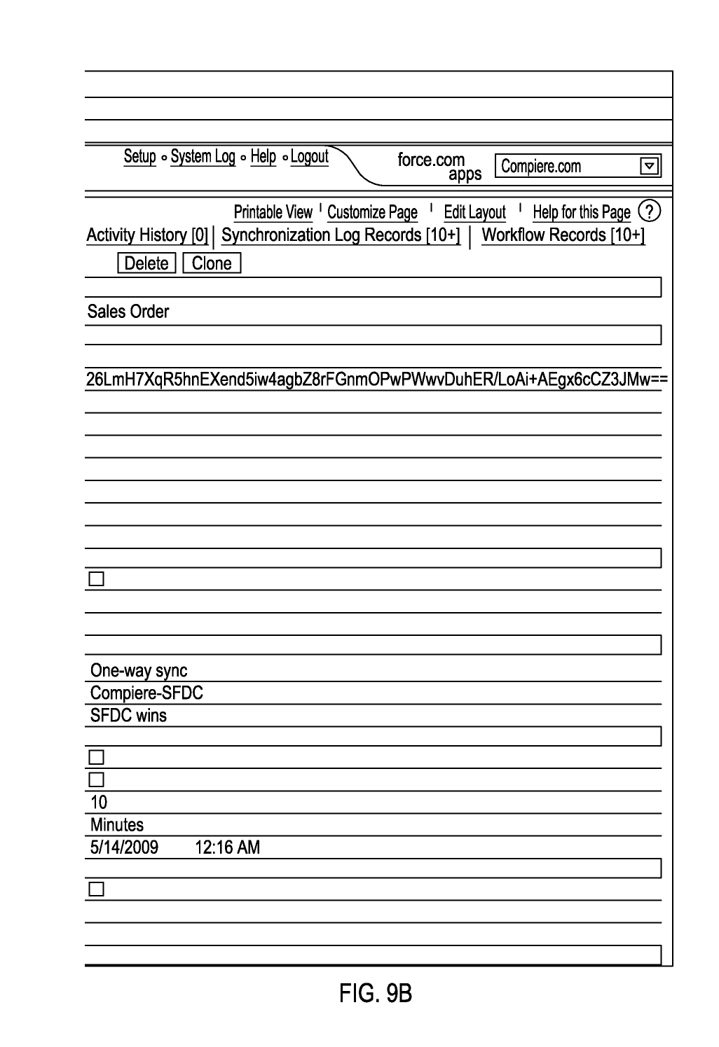

FIGS. 9A and 9B illustrates an exemplary third party user interface 900. The application illustrated in the user interface 900 makes use of the web services (i.e., a search executed from the interface access 332). In the illustrated user interface 900, a SALESFORCE application passes parameters under a “Compiere Credentials” section of the interface 900 to the web service enabled system 300.

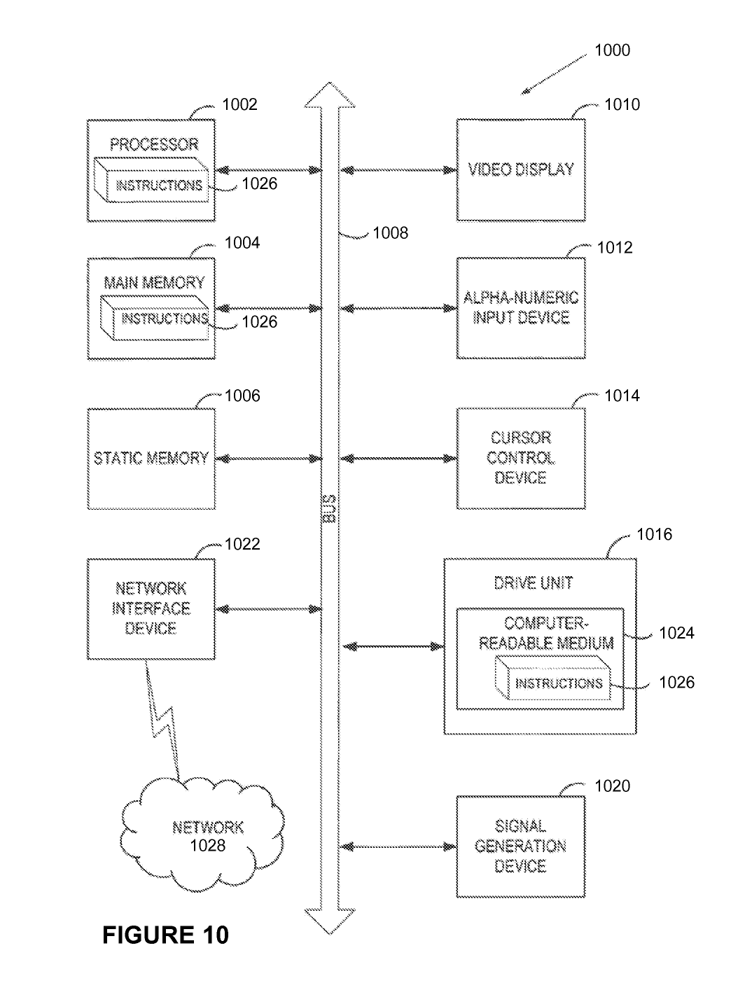

FIG. 10 shows a diagrammatic representation of machine in the exemplary form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1000 includes a processor 1002 (e.g., a central processing unit (CPU), a graphics processing unit (GPU) or both), a main memory 1004 (e.g., read only memory (ROM), flash memory, dynamic random access memory (DRAM) such as synchronous DRAM (SDRAM) or Rambus DRAM (RDRAM), etc.) and a static memory 1006 (e.g., flash memory, static random access memory (SRAM), etc.), which communicate with each other via a bus 1008.

The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1020 (e.g., a speaker) and a network interface device 1022.

The disk drive unit 1016 includes a computer-readable medium 1024 on which is stored one or more sets of instructions (e.g., software 1026) embodying any one or more of the methodologies or functions described herein. The software 1026 may also reside, completely or at least partially, within the main memory 1004 and/or within the processor 1002 during execution thereof by the computer system 1000, the main memory 1004 and the processor 1002 also constituting computer-readable media.

The software 1026 may further be transmitted or received over a network 1028 via the network interface device 1022.

While the computer-readable medium 1024 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be noted that the enterprise application system is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method comprising:
receiving a web service request to access data in an enterprise resource application;
processing the web service request using metadata in the enterprise resource application; and
generating a textual response using the metadata.

2. The computer-implemented method of claim 1, wherein the textual response is an XML response.

3. The computer-implemented method of claim 1, further comprising transmitting the textual response to a third party application.

4. The computer-implemented method of claim 1, wherein the web service request is a URL, the URL comprising an action, an object and parameters.

5. The computer-implemented method of claim 4, wherein processing the web service request comprises extracting the action, object and parameters from the URL.

6. The computer-implemented method of claim 5, wherein processing the web service request comprises mapping the action, object and parameters to metadata.

7. The computer-implemented method of claim 1, wherein the web service request is a RESTful web service request.

8. The computer-implemented method of claim 1, wherein processing the web service request comprises adding a data object that includes metadata to the enterprise resource application.

9. The computer-implemented method of claim 1, wherein processing the web service request comprises modifying a data object that includes metadata in the enterprise resource application.

10. A non-transitory computer-readable storage media having computer executable instructions stored thereon which cause a computer system to carry out a method when executed, the method comprising:
receiving a web service request to access data in an enterprise resource application;
processing the web service request using metadata in the enterprise resource application; and
generating a textual response using the metadata.

11. A computer-implemented method comprising:
receiving a request to modify metadata in a data dictionary;
modifying the metadata according to the request; and
generating a web service corresponding to the modified metadata.

12. The computer-implemented method of claim 11, wherein the request comprises an addition of a data object, the data object comprising metadata.

13. The computer-implemented method of claim 11, wherein the request comprises a modification of a data object, the data object comprising metadata.

14. The computer-implemented method of claim 11, wherein the request comprises a web service request.

15. A non-transitory computer-readable storage media having computer executable instructions stored thereon which cause a computer system to carry out a method when executed, the method comprising:
receiving a request to modify metadata in a data dictionary;
modifying the metadata according to the request; and
generating a web service corresponding to the modified metadata.

16. A non-transitory computer system comprising:
a web layer configured to receive requests to access a business representation of data and deliver a response including the business representation of the data;
a data dictionary configured to store metadata; and
a persistent layer operatively coupled to the web layer and the data dictionary, the persistent layer configured to process the web service request using the metadata and generate the response.

17. The computer system of claim 16, further comprising application logic configured to store business constraints, the persistent layer operatively coupled to the persistent layer and configured to process the web service request using the metadata and the business constraints.

18. The computer system of claim 16, wherein the metadata comprises windows, taps and fields.

19. The computer system of claim 16, wherein the web layer comprises a web services application interface and a user interface application.

20. The computer system of claim 16, wherein the request comprises a uniform resource locator (URL).

21. The computer system of claim 16, wherein the request comprises an action, an object and one or more parameters.

22. The computer system of claim 16, wherein the response comprises extensible markup language (XML) content.
